(19) United States
(12) Patent Application Publication
(10) Pub. No.: US 2017/0061509 A1
(43) Pub. Date: Mar. 2, 2017

(54) SYSTEM FOR PROVIDING LOCATION SERVICES IN FACILITATING IN-PERSON EXCHANGE OF GOODS OR SERVICES

(71) Applicant: Stubblr Inc., Brooklyn, NY (US)

(72) Inventors: Steven Rosenberg, Brooklyn, NY (US); Paul Yankowitz, Westfield, NJ (US)

(21) Appl. No.: 15/231,484

(22) Filed: Aug. 8, 2016

Related U.S. Application Data
(60) Provisional application No. 62/202,777, filed on Aug. 7, 2015.

(51) Int. Cl. G06Q 30/06; H04W 4/02; G06Q 30/02; H04L 29/08; G06F 17/30

(52) U.S. Cl. CPC G06Q 30/0601; H04L 67/306; G06F 17/30864; G06Q 30/0207; H04W 4/02

(57) ABSTRACT

The present invention relates to a system and method for facilitating the in person exchange of goods or services using a electronic service platform. The present invention provides for listing tickets for sale for a particular event, creating a listing for desired tickets for a particular event, facilitating communication between buyers and sellers of tickets, facilitating an in person transaction for tickets, verifying a transaction has taken place, and for rating a transaction.

### CROSS-REFERENCE AND CLAIM OF PRIORITY

The present invention claims priority to U.S. Provisional Application No. 62/202,777, entitled SYSTEM FOR PROVIDING LOCATION SERVICES IN FACILITATING IN-PERSON EXCHANGE OF GOODS OR SERVICES, Rosenberg et al., filed Aug. 7, 2015, which is incorporated by reference herein in its entirety.

### FIELD OF THE INVENTION

The present application generally relates to systems and methods for providing location services in conjunction with processing electronic transactions. More specifically, the present invention relates to systems and methods for facilitating in-person transactions using an electronic service platform.

### BACKGROUND OF THE INVENTION

Typically third-party buyers and sellers of tickets to events are individuals and have had no prior experience or interaction with one another and have never met face-to-face. Purchasing tickets from scalpers or other third-parties can be intimidating. As a result, many prospective purchasers avoid or are at least hesitant to engage people “on the street” selling or buying tickets. What is needed is a system that can bring buyers and sellers together over a secure, trusted channel or service.

Facilitating in-person transactions for goods sold over a network can be difficult. For example, it may be very difficult for a person looking to purchase a ticket for a live event to locate a suitable ticket and to also complete the transaction to purchase the ticket, especially closer to the start time of the event. Many times, a person may have extra tickets for an event, may not be able to attend an event, or not have enough tickets for an event. Attempting to reach a buyer or seller close to an event start time can be problematic. Problems exist in searching for a desired event, locating a desirable ticket or set of tickets, and in completing the transaction for the purchase of the ticket. Specifically, existing methods do not provide a solution for locating the exact location of a person who is buying or selling tickets. Furthermore, existing methods do not offer adequate assurance that transactions have been satisfactorily completed, and also do not provide a solution for identifying reliable buyers and sellers.

Several different methods exist for facilitating transactions for tickets for an event. A first method described in LOCATION-BASED PRESENTATIONS OF TICKET OPPORTUNITIES, U.S. P.G. Pub. 2014/0379309, filed Jun. 3, 2014 (Scarborough), which is incorporated by reference herein in its entirety, describes a method wherein “[l]ocation-based information is used to estimate which tickets are likely to be unused and to provide channels through which such tickets can be reassigned to others capable of attending the appropriate event.” Scarborough uses location information to determine when a ticket holder is far enough away from an event location at the time of an event such that the ticket holder would not be able to attend the event. For example, if a ticket holder is hundreds of miles away from an event location that starts in fifteen minutes, the event ticket may be processed such that it may be reassigned or resold to another patron rather than going unused and seats empty. Scarborough also facilitates the reassigning of the ticket in addition to determining when a ticket holder will not be able to attend and event. Scarborough does not attempt to bring buyers and sellers together.

In another method described in TICKET REMARKETING SYSTEM AND METHOD, U.S. P.G. Pub. 2002/0049658, filed Aug. 29, 2001 (Davidson et al.), which is incorporated by reference herein in its entirety, “[a] method for using a computer network to facilitate the resale of season tickets” is detailed. The system and method in Davidson et al. provides a season ticket holder with the ability to list one or more tickets they hold for sale on a website or electronic application. The system and method in Davidson et al. does not incorporate any location determining functionality and only allows users to list tickets for sale for a particular venue. Davidson et al. in no way provides users with any way to locate other users to facilitate a transaction.

In yet another method described in METHOD FOR A TICKET EXCHANGE ACROSS DIFFERENT SYSTEMS OF RECORD, filed May 4, 2012 (Lester et al.), which is incorporated herein by reference in its entirety. In Lester et al. a “method for exchange of semi-fungible goods or service” that relates to a “trading system” wherein a user may set specific parameters for executing a trade for goods or services. The system in Lester et al. may also facilitate matching users to facilitate a desired trade. However, Lester et al. does not describe any method for providing the physical location of buyers and sellers of goods.

What these and all other existing methods for facilitating goods transactions lack is a system or method for providing the physical location of buyers or sellers of goods at an appropriate time. Existing systems and methods also lack sufficient methods for identifying a desirable good for purchase, listing a good for sale, locating a good for purchase or sale, processing and verifying a transaction, facilitating communication, and verifying a transaction has occurred.

Presently, there exists no secure, trusted online solution for users who wish to buy or sell tickets close to the start time of an event at or near the location of the event itself. What is needed is a safe, secure and trusted system for electronically listing tickets for sale for a particular event, creating a listing for desired tickets for a particular event, facilitating communication between buyers and sellers of tickets, facilitating an in person transaction for tickets, verifying a transaction has taken place, and for rating a transaction.

### SUMMARY OF THE INVENTION

The present invention provides an electronic platform to match buyers and sellers of tickets near the location of an event in real time using cell phone or mobile information, social network information, and geo-location tagging. The present invention provides an electronic exchange for the last minute purchase and sale of tickets. More specifically, the present invention provides a system and method for sellers with tickets in hand to locate buyers wishing to buy said tickets and vice versa. By creating profiles associated with buyers and/or sellers and accounts for users, the system establishes a trusted network of individuals to facilitate selecting a location to meet and consummate transactions.

The present invention provides a user with the ability to locate an event based on a location (such as a city), an event type, an artist or performer, or by an event name. A user may view tickets available for purchase that are being sold by other users, or electronic listings of tickets provided by the venue or event organizers. A user may also list tickets for sale, or post a listing requesting specific tickets. A user may use a listing of tickets for purchase or sale to facilitate their transaction, or may use a map to locate tickets/sellers near the user/buyer, or to locate prospective ticket buyers near the user/seller. After a user has identified a specific buyer or seller of tickets, the user may communicate with the other party and arrange a transaction for the tickets. The present invention may also provide users with notifications indicating that there are other parties, who may be physically nearby, who may want to purchase tickets the user is selling, or who may be selling tickets the user has requested. The notifications may appear as notifications on a menu or status bar, may be email notifications, may be push notifications delivered to a phone notification bar, may be lock screen notifications, or may be text messages. Users may opt into or out of any combinations of notifications they wish. Users may also choose to receive notifications for possible transactions of interest, nearby transactions, nearby events, special offers or deals, or other limited time or special offers. The present invention also provides users with the ability to complete the transaction and to verify that the transaction has taken place. After a transaction, the user may rate the other party involved in the transaction.

A user of the electronic platform may create a user profile comprising specific information about the user. A buyer using the electronic platform of the present invention may identify tickets to purchase by locating a particular event by searching for a date range, location, venue, artist or performer, or event name. The buyer can locate tickets by viewing a map displaying the physical location of tickets for sale, or by browsing a listing of tickets for sale near the event location. The buyer may also purchase tickets for sale provided by other ticket resellers provided in an electronic ticket listing. Historical data related to past transactions and listings may be included as part of a user's profile and may be used to present an indication of trustworthiness, e.g., transaction went smoothly—ticket received, payment received.

A seller using the electronic platform of the present invention may create a listing of tickets for sale. A prospective buyer can locate the seller's offer by locating the seller on a map or by viewing the seller's ticket listing. The seller may also be provided with the option to sell the tickets through a secondary ticket market connected to or affiliated with the electronic platform.

The present invention may generate revenue by collecting a transaction fee from buyers and sellers exchanging tickets using the electronic platform, by commissions from electronic ticket listings that are listed by other major ticket exchange platforms, from advertising revenue, and from primary ticket sales on tickets sold directly from the electronic platform.

In a first embodiment, the present invention provides a system for facilitating the in-person exchange of goods or services, the system comprising: a first mobile device associated with a first user; a second mobile device associated with a second user; an application server having a processor and a memory, the memory comprising computer executable code that when executed by the processor adapted to: receive a posting for an offering comprising a set of offering information from the first mobile device; store the offering in a database; receive a request for the offering from the second mobile device; in response to the request, provide the offering and the set of offering information to the second mobile device; receive a first set of location information from the first mobile device and a second set of location information from the second mobile device; provide the first set of location information to the second mobile device if a set of criteria are met; and facilitate and verify an exchange of goods or services between the first user and the second user by receiving a set of verification and purchase information from the first and second mobile devices.

The system of the above embodiment may further comprise wherein a first user profile associated with the first user and a second user profile associated with the second user are stored on the application server. The system application server may further adapted to: provide the second mobile device associated with the second user a set of search tools; receive a search query from the second mobile device, the search query specifying a set of desired criteria relating to an event; provide the second mobile device with a set of identified events related to the query; receive an event selection from the second mobile device, the event selection comprising a specific event from the set of identified events; and provide a set of offerings related to the event selection to the second mobile device. The request for the offering may comprise an offering from the set of offerings. The search query may comprise one or more of a location, a date, a date range, an event type, an event name, an artist name, a performer name, and an event name. The set of offerings may be provided to the second mobile device on a map displayed on the second mobile device. The map may be displayed to the second mobile device if a set of map display criteria are met. The set of map display criteria may include a proximity to an event venue and a temporal proximity to an event time. The set of verification and purchase information may be provided by a third party payment processor. The set of verification and purchase information may comprise a receipt. The computer executable code executed by the processor of the application server may be further adapted to provide a notification to the second mobile device associated with the second user based on a set of notification criteria stored in the second user profile. The first mobile device and the second mobile device may monitor and collect a set of tracked information related to the first mobile device and the second mobile device and related to the first user and the second user and transmit the tracked information to the application server, and the application server may be further adapted to: provide a set of location based offers to the second user based in part on the set of tracked information. The tracked information may comprise global positioning system information, cell tower location information, wireless network information, and social media information.

In another embodiment, the present invention provides a method for facilitating the in-person exchange of goods or services through an electronic platform, the method comprising: receiving a posting for an offering associated with an event, the event being associated with a set of event information, from a first party, the offering comprising a set of offering information; receiving a request for the set of event information from a second party; in response to the request, gathering a set of location data from the first party and upon determining that a set of criteria are met, displaying the location of the offering on a map; receiving a request for the set of offering information from the second party, the request having been generated in response to the second party selecting the offering from the map; facilitating an in person exchange of goods or services between the first party and second party by providing each of the first and second parties with a set of location information about the other party.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIGS. 1-52 and 60 provide a set of screenshots of an exemplary user interface for the electronic platform.

FIG. 53 provides a flow chart depicting the process for posting a request for a ticket using the electronic platform.

FIG. 54 provides a flow chart depicting the process for posting a listing of a set of tickets for sale using the electronic platform.

FIG. 55 provides a flow chart depicting the process for engaging in an in person transaction facilitated by the electronic platform.

FIG. 56 provides a flow chart depicting the process for viewing the location of buyers or sellers of tickets using the electronic platform.

FIG. 57 provides an exemplary receipt for a transaction using the electronic platform.

FIG. 58 provides a network diagram for an exemplary embodiment of the electronic platform.

FIG. 59 provides a block system diagram for a mobile device and an application server.

### DETAILED DESCRIPTION OF THE INVENTION

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

The present invention provides an electronic platform that connects users to other users to facilitate the transaction of goods or services. In one embodiment, the present invention provides users with an electronic marketplace for the exchange of event tickets. Users create a profile and use the electronic platform to post listings for the sale or purchase of tickets for a particular event. Users may locate ticket exchange opportunities by locating the opportunities on a map of the area around an event venue, or by viewing a listing of tickets for purchase or sale for a particular event. Users may locate a particular event by searching for an event or by applying filters to identify a particular event. Events may be searched for or filtered by, for example, artists, venues, cities, dates, or other criteria.

The present invention provides an electronic platform that provides users with the exact location of another user for the purpose of facilitating an in person transaction for an event ticket. Users may locate other users by viewing a map displaying other platform users, or by selecting an offering from a listing of offerings for a particular event.

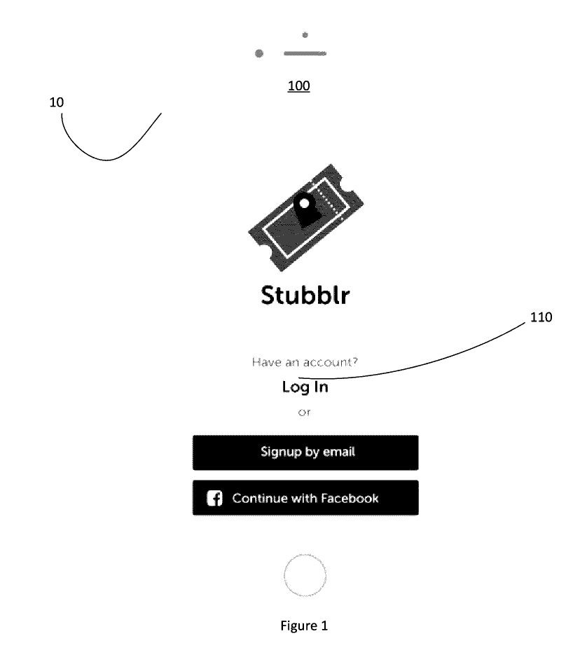

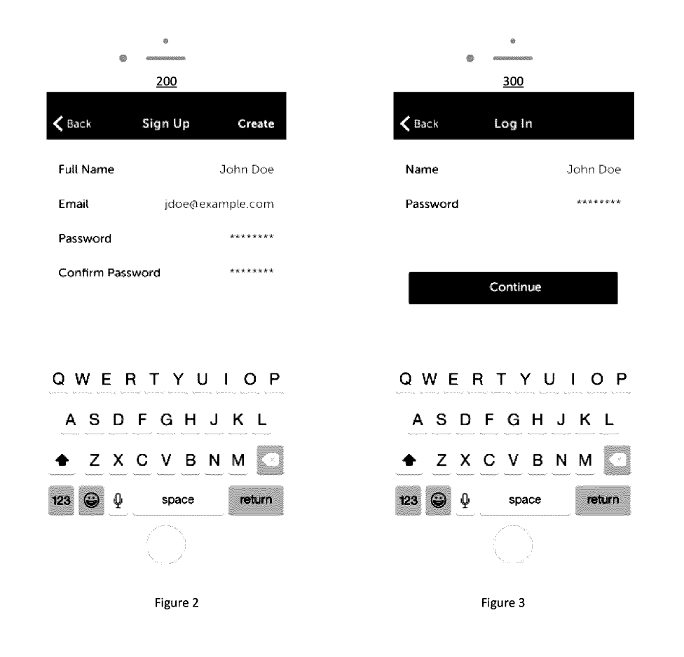

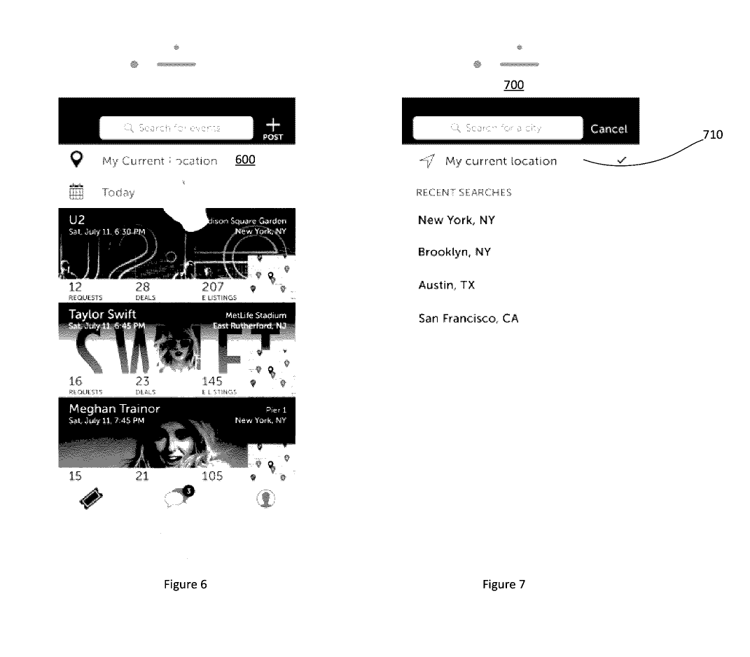

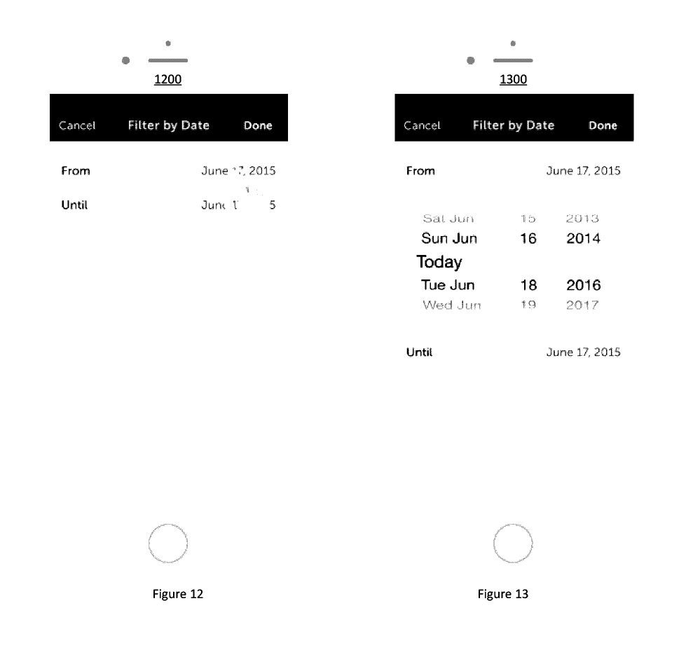

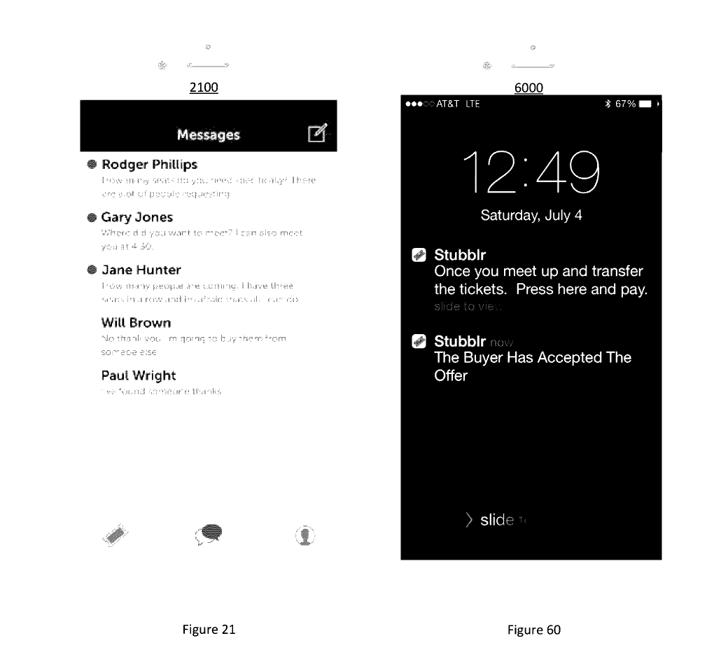

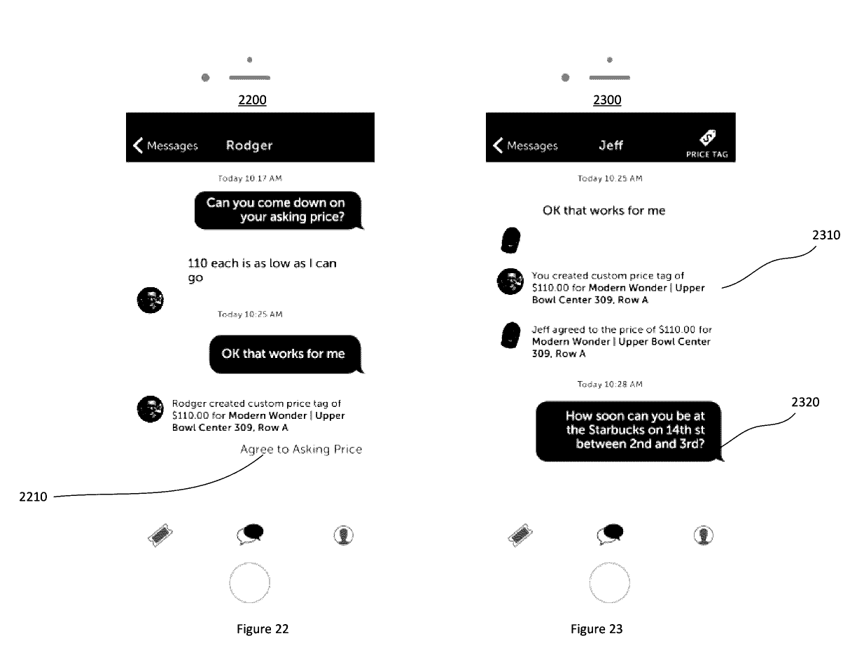

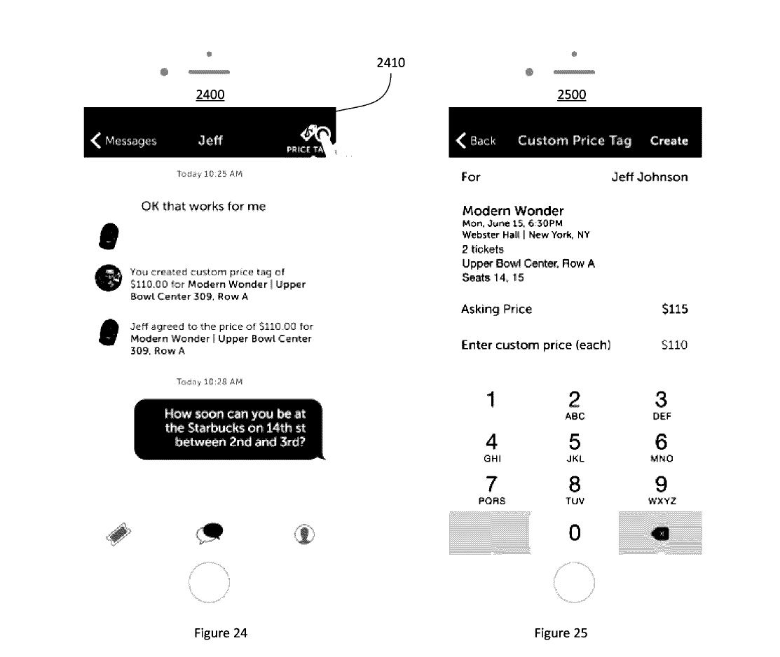

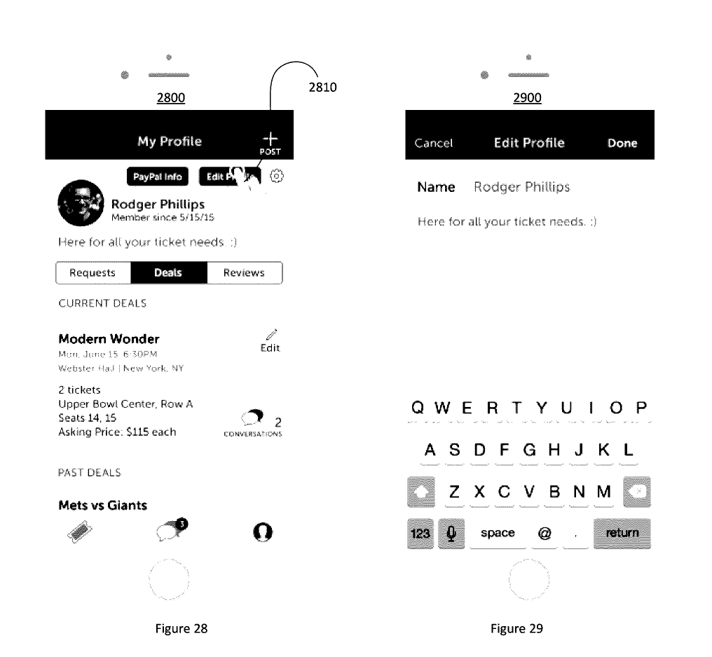

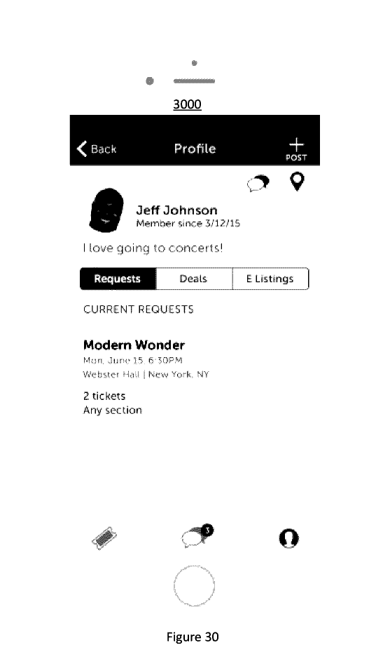

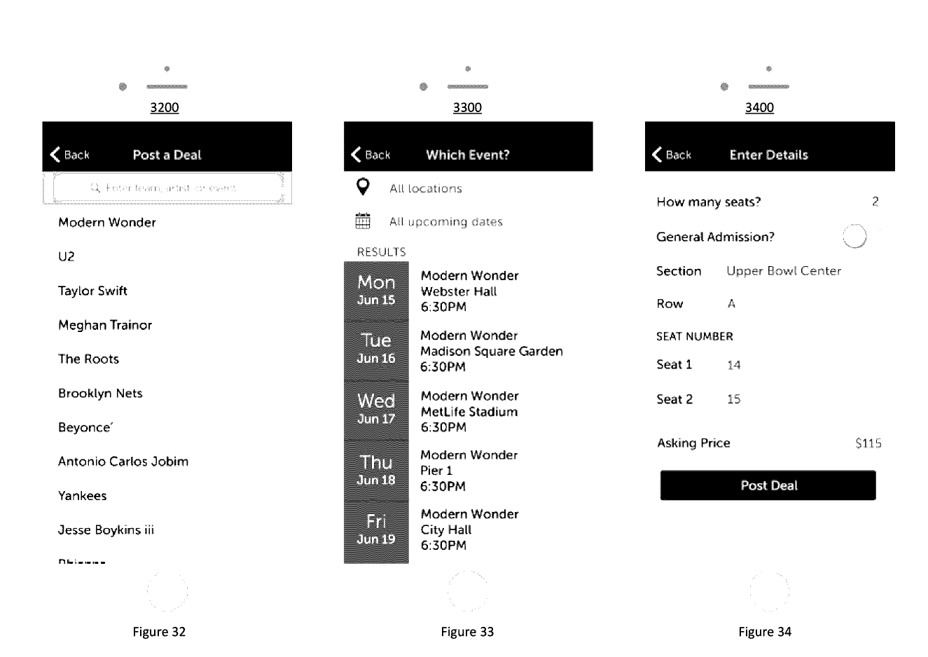

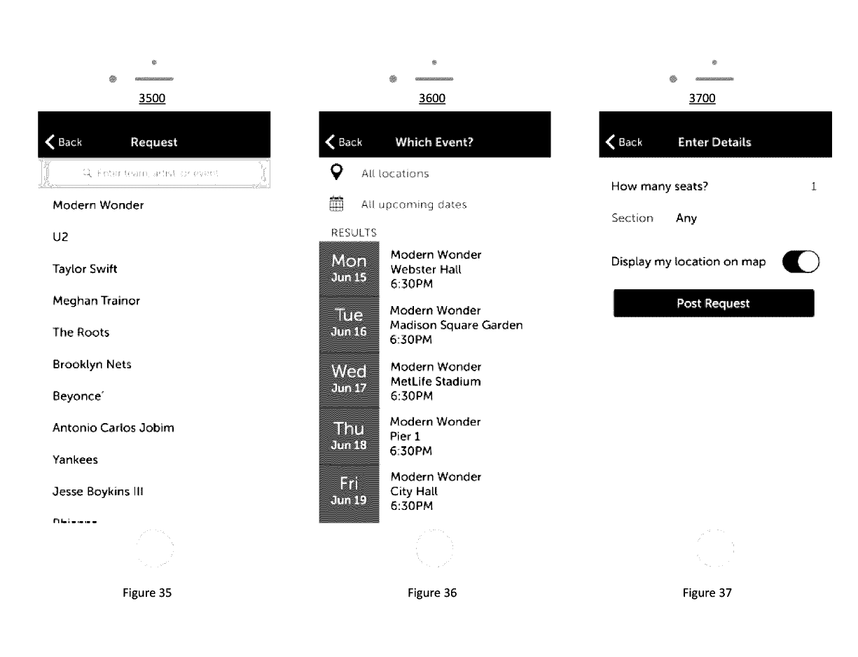

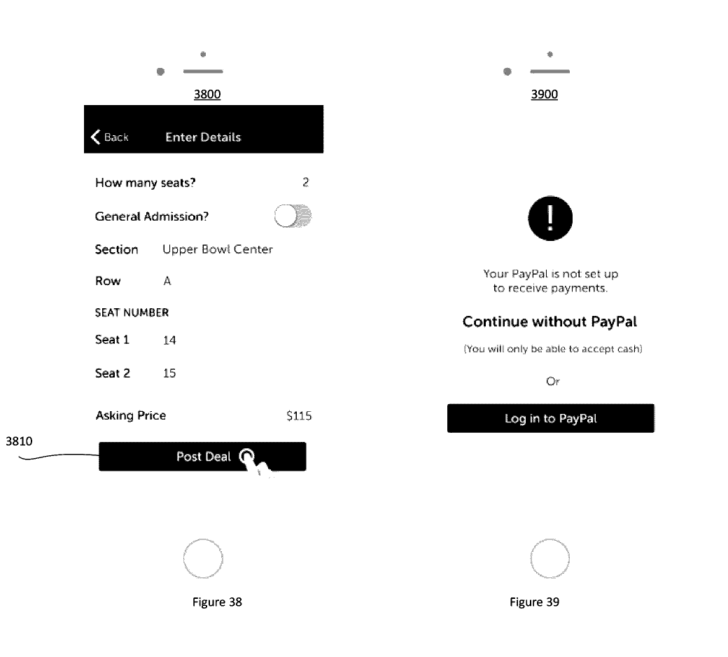

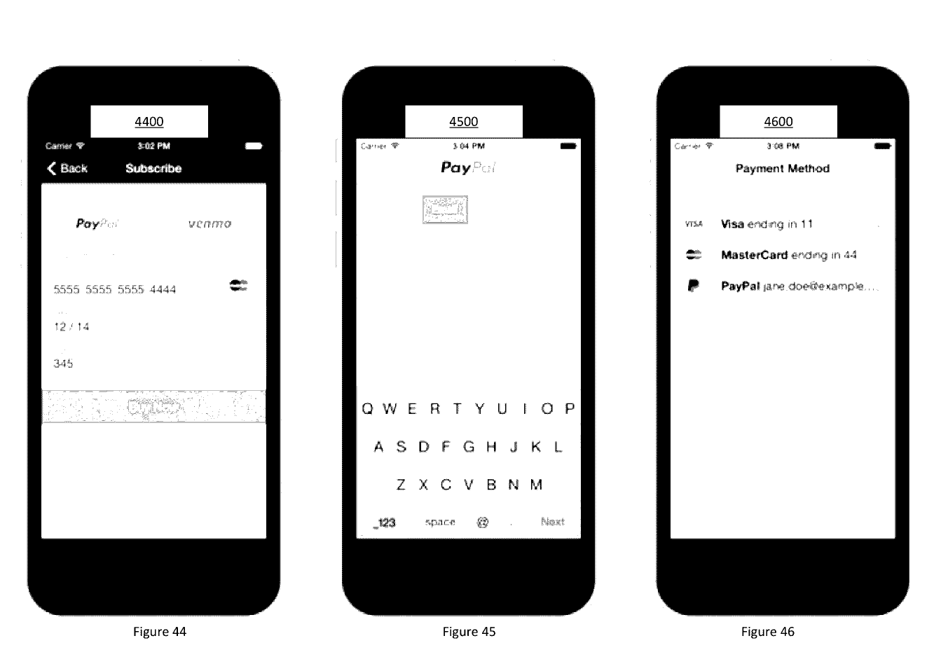

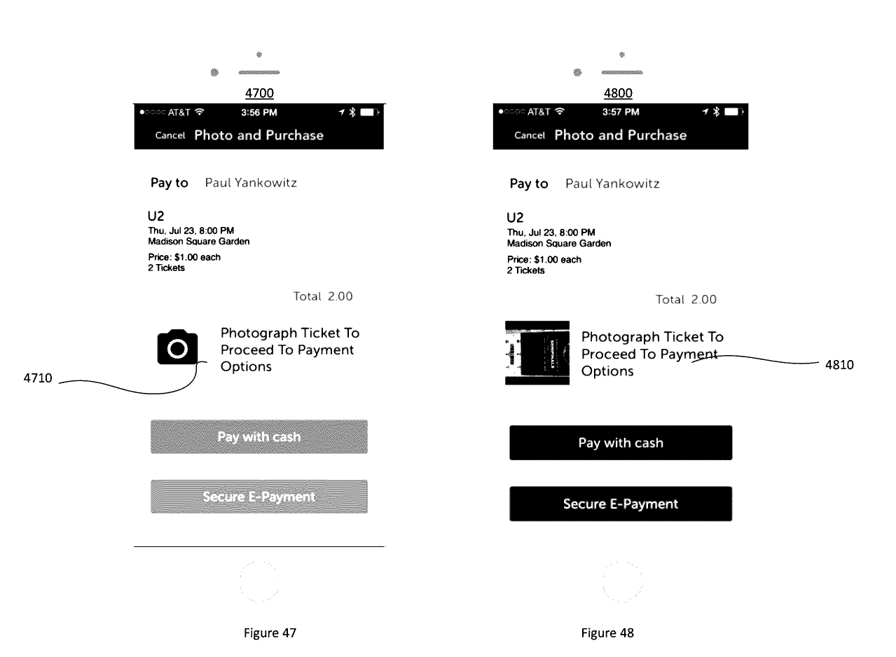

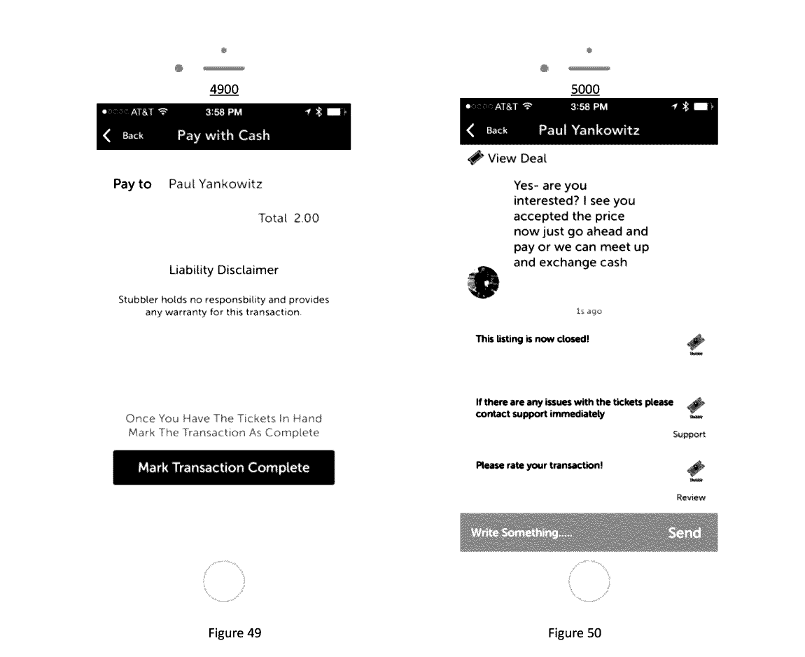

With reference now to FIGS. 1-52, a series of screenshots illustrating different aspects of the graphic user interface for the mobile app for the electronic platform of the present invention are provided. When a user first opens the mobile app, the user is presented with the log in screen 100 shown in FIG. 1. If the user already has an account with the electronic platform, the user may log in by selecting the log in option 110. On sign-up screen 200 the user may enter personal information including name and email for their desired user account, or if the user already has an account they may sign in on log in screen 300 using their username and password.

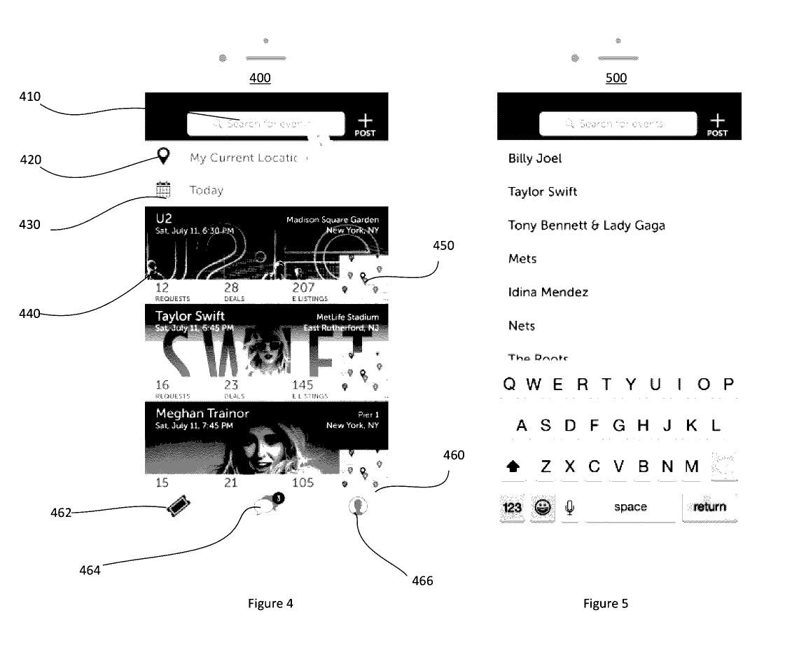

The home screen 400 shown in FIG. 4 provides the user with access to the primary features of the mobile application. The user can search for events using field 410, select the current or desired event location using the location option 420, and can specify a date range to search for events using the date option 430. The list of events 440 meeting the selected criteria are shown below the filtering options. For each event listing 440 the number of ticket wanted or “requests”, tickets for sale or “deals”, and electronic listings from other providers “e-listings” are displayed to the user. The user can select an event to view these listings however, the user may also select the event map 450 to view a map of the geographic area near the event venue. This map, shown in greater detail in FIG. 16, provides the user with a visual representation of all tickets wanted and for sale near the event venue if certain criteria are met. The criteria may be, for example, proximity to the event venue or proximity to the event start date and time. The menu bar 460 provides a user with easy access to the home screen using the home screen button 462, user messages using button 464, and the user's profile using button 466. The menu bar 460 also indicates to the user which page the user is currently on by highlighting the current page option on the menu bar 460. The map may show all sellers and buyers associated with an event to help convey an indication of supply/demand for tickets to the event.

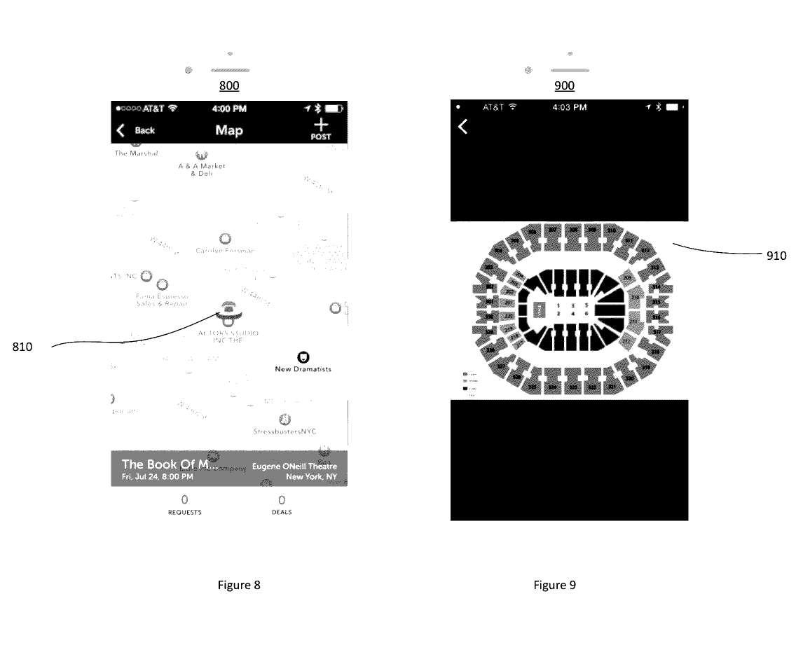

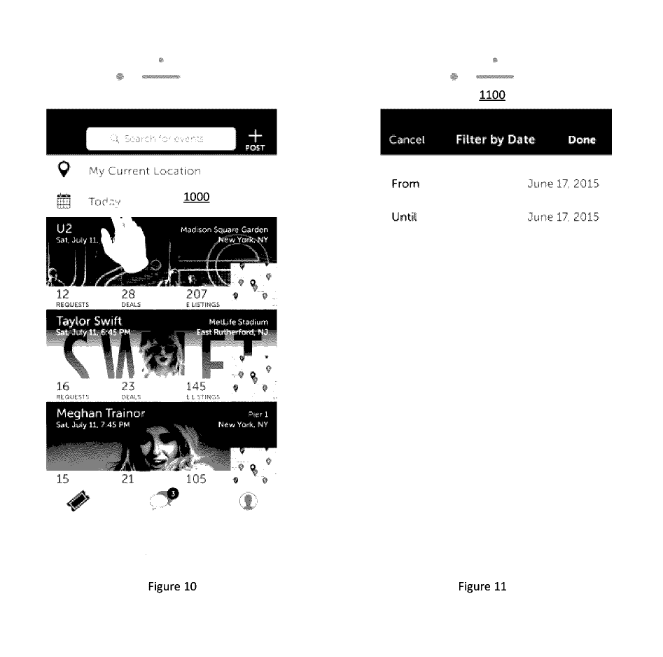

With reference now to FIG. 5, an example of a search filter screen 500 is provided. Using the search filter screen 500, a user may search for events using search terms including but not limited to artist name, event name, team name, event location. FIG. 6 illustrates a user on the home screen navigating to the filter by location screen 700 by selecting the location option 600. The user may choose to filter by the current location 710 or by searching for another desired location. The user may also choose an event location by selecting the location from a map such as the map 800 shown in FIG. 8. The selected venue 810 is displayed with a special icon on the map screen 800, and when selected, details such as the seating layout 910 shown on screen 900 of FIG. 9 may be viewed by the user. In FIG. 10, the user is selecting the filter by date option 1000 to view the filter by date screen 1100. The user may navigate through the menus 1100, 1200, and 1300 of FIGS. 11-13 to specify a desired date range. This date range will then be used to filter events on the home screen.

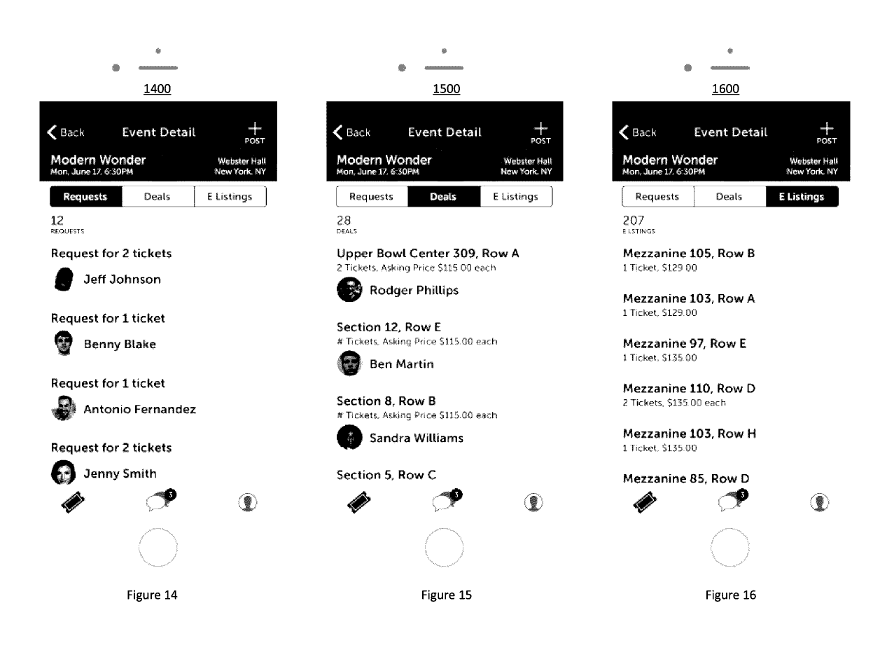

FIGS. 14-16 provide an embodiment of a set of menu and information screens that provide details for a particular event. The requests screen 1400 for the event displays all current requests for tickets for that particular event. The deals screen 1500 displays all the tickets currently being offered by other users of the electronic platform. The e-listings screen 1600 displays all ticket listings provided by third party or affiliated ticket resellers. Each of the screens 1400, 1500, and 1600 also provide details about the time, date, and location of the selected event.

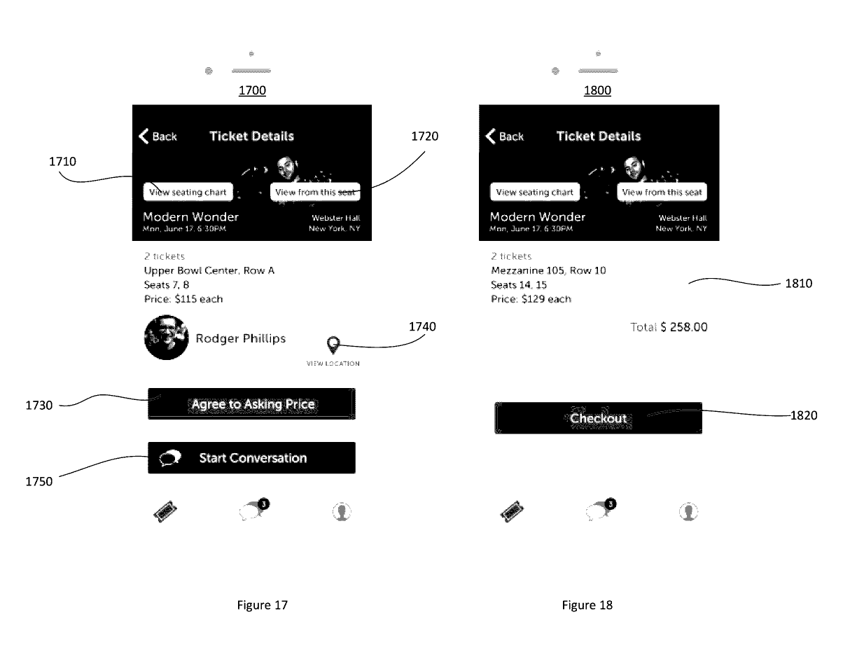

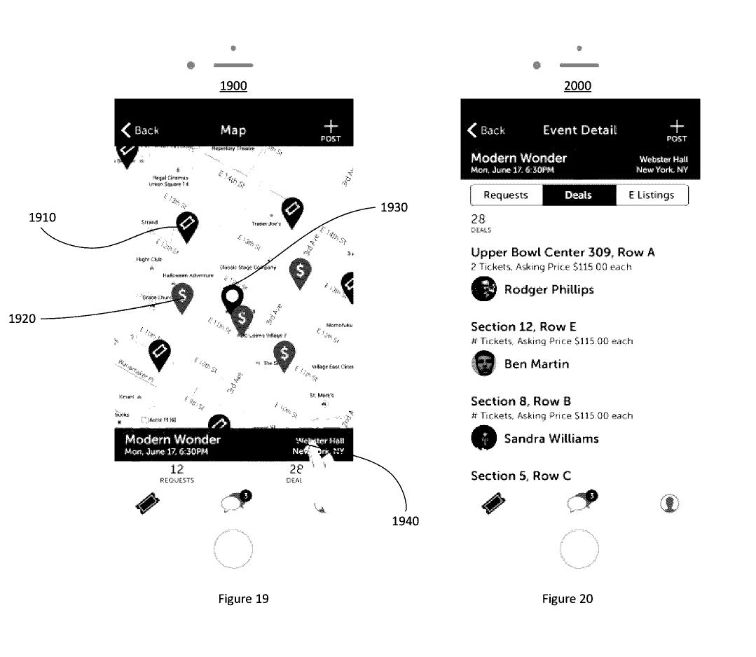

FIGS. 17 and 18 illustrate menu and information screens for a selected ticket for a particular event. The details screen 1700 provides a user with information about the particular ticket including the location, price, and seller information. The user may also view a seating chart using the button 1710 or may be provided with a view from the seat corresponding to the ticket using the button 1720. To facilitate an in-person ticket exchange, the user may also select the view location button 1740. Upon selecting the view location button 1740, the user would be presented with a map such as the map 1900 shown in FIG. 19. The map 1900 provides the user with a map displaying the event location 1930. Surrounding the event location 1930 are a set of ticket deal locations 1910 and ticket request locations 1920. Selecting a particular request 1920 or deal 1910 will take the user to the request or deal screen for that corresponds to the selected deal 1910 or request 1940. If the user selects the event option 1940 the user will be displayed with the list of all deals for the particular event 2000.

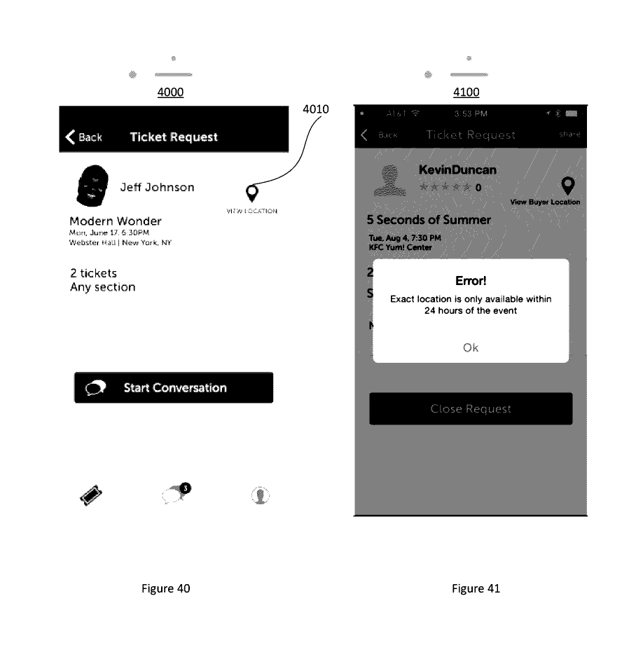

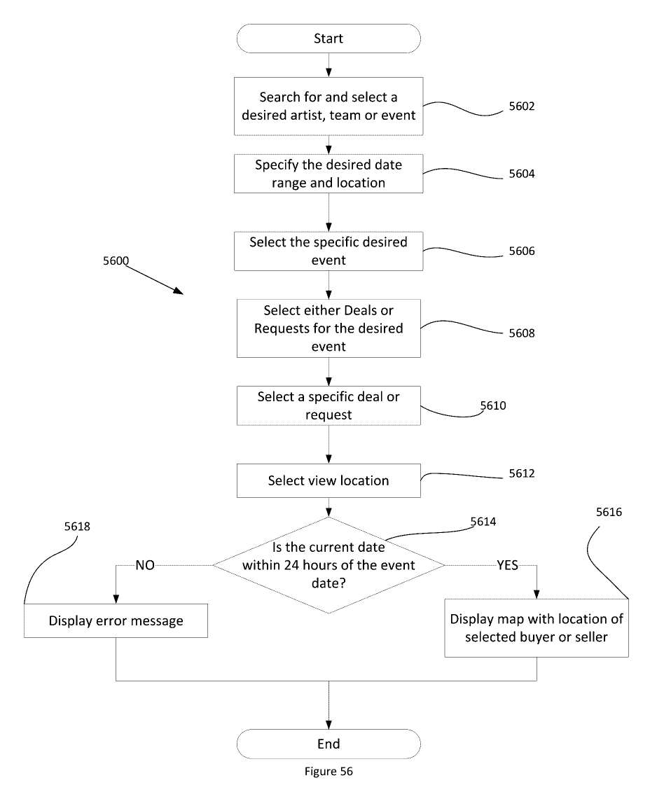

The map 1900 may also display only a selected location for a particular ticket deal or request if selected from, for example, the ticket detail screen 1700. The location of the ticket request or deal may only be displayed if the user is within a certain proximity to the location and date of the event. For example, if a user selects the view location option 4010 from the ticket request screen shown in FIG. 40 more than 24 hours from the event start time they may be presented with the error screen 4100 shown in FIG. 41 indicating that the exact location information is only available within 24 hours of the event. By limiting the amount of time or other condition for disseminating a user's location information the invention helps protect against improper use of user information. The location feature may also be selectively enabled during the transaction process. The process for viewing the location of a deal or request is shown in steps 5602-5618 of flowchart 5600 in FIG. 56. The location of the deal or request may be determined by taking information from the user that posted the deal or request. For example, if a user posts a ticket deal, GPS, cellular tower location, other wireless radio information, or social media information may all be used to determine the location of that user. The system will track the user's location such that it may be provided to other users through, for example, the map 1900. The location data gathered by the system may also be used to guide users to one another to facilitate an in person exchange by providing directions or other location data to each party. In one manner, rather than show exact location of users the system may indicate a proximity or range of the user to the location of the event or the location of the prospective seller/buyer.

With reference back to FIG. 17, the user may also start a conversation with the user offering the ticket deal by selecting the button 1750, or may agree to purchase the ticket by selecting the agree to asking price button 1730. If the user agrees to the asking price the user will be presented with the cart screen 1800 that comprises final ticket purchase information 1810, and an option 1820 to purchase the ticket deal. In one manner of operation, the system may be configured to only show specific location information upon agreement of the parties to execute a sale/transaction.

A user may view any message the user has received using the messages screen 2100, which is accessible using the messages button on the menu bar. If the user selects a particular message thread, they may be presented with the conversation as shown in conversation screen 2200. The users may discuss the ticket price, pickup location, and other topics relating to the exchange of tickets. A seller may also set a user specific ticket price that is only available to the buyer in the conversation. A user may agree to this special asking price by selecting the agree to asking price option 2210. The user is then presented with a notification and details 2310 regarding the custom asking price. The custom asking price may be created by selecting the price tag option 2410 shown in the conversation screen 2400. The details of the specific offer can be input in the custom price tag screen 2500. The users may also negotiate using the mobile app to agree on a compromise for the price, amount, and pickup location of the ticket. The present invention provides for the users to both communicate and set custom prices using the price tag option 2410. Users are able to negotiate whatever arrangement for the ticket purchase they wish using the mobile app of the present invention. The text field 2320 may be an active button that when selected will launch the map 1900 or a similar navigation application or mapping service. Any messages received by a user may appear as notifications on a menu or status bar or on a lock screen. Users may also receive notifications for other events including but not limited to notifications indicating that there are other parties, who may be physically nearby, who may want to purchase tickets the user is selling, who may be selling tickets the user has requested, or possible transactions of interest, nearby transactions, nearby events, special offers or deals, or other limited time or special offers. The notifications may appear as notifications on a menu or status bar, may be email notifications, may be push notifications delivered to a phone notification bar, may be lock screen notifications, or may be text messages. Users may opt into or out of any combinations of notifications they wish by selecting from a set of notification options in their user profile or from a settings menu. Example lock screen notifications are shown on screen 6000 in FIG. 60.

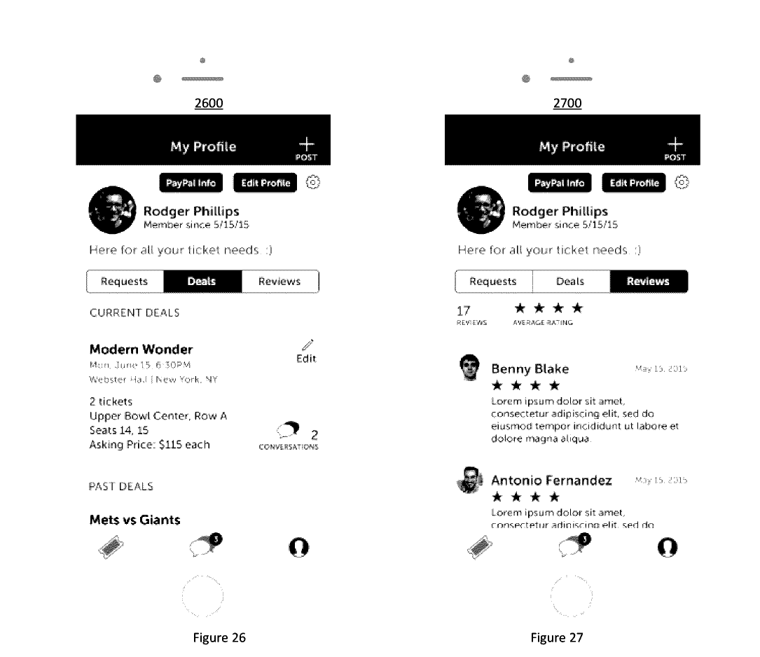

A user may view their profile by selecting the profile option from the menu bar. The profile deals screen 2600 shown in FIG. 26 provides a user with a summary of deals posted by that user. The user may view conversations related to the deal and may also edit deal information. The profile screen also provides the user with the ability to edit profile information using profile editor 2900 by selecting the edit profile button 2810 shown in profile screen 2800. The reviews screen 2700 provides a user with a summary of all reviews posted for the particular user. A user may also view all requests posted by the user by viewing the profile requests screen 3000. The user may view, edit, or delete requests from this screen.

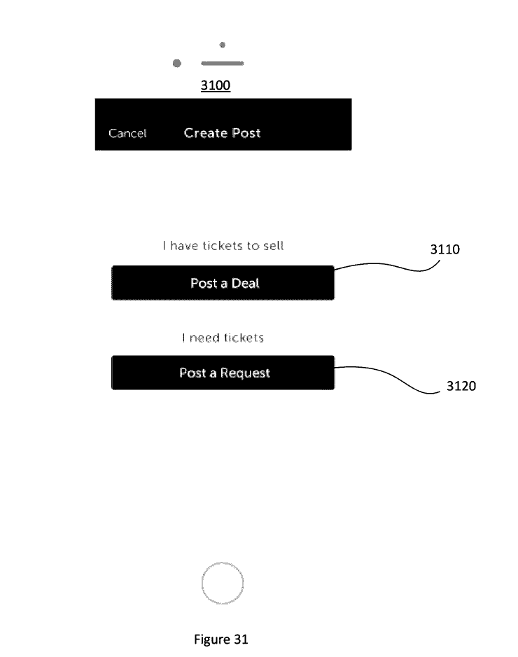

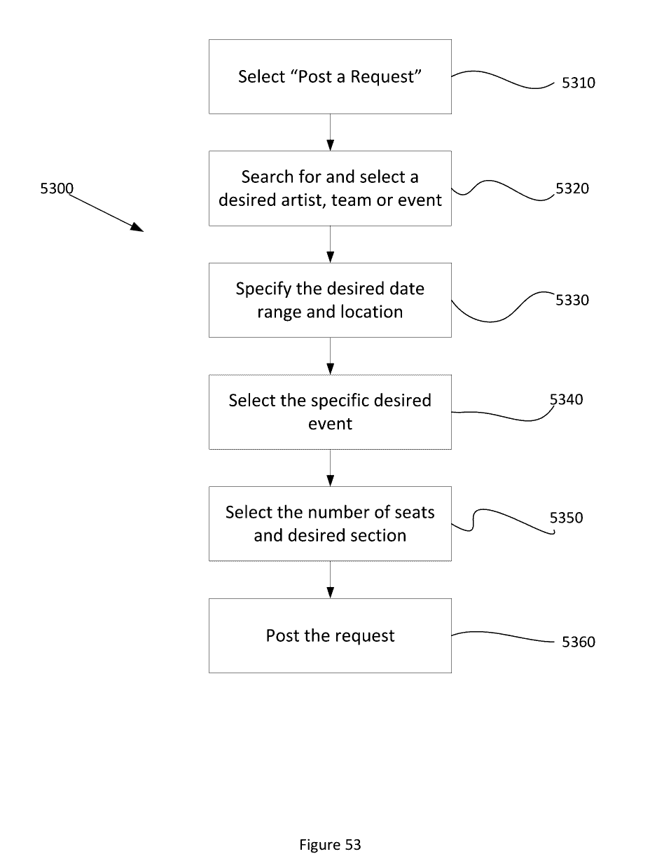

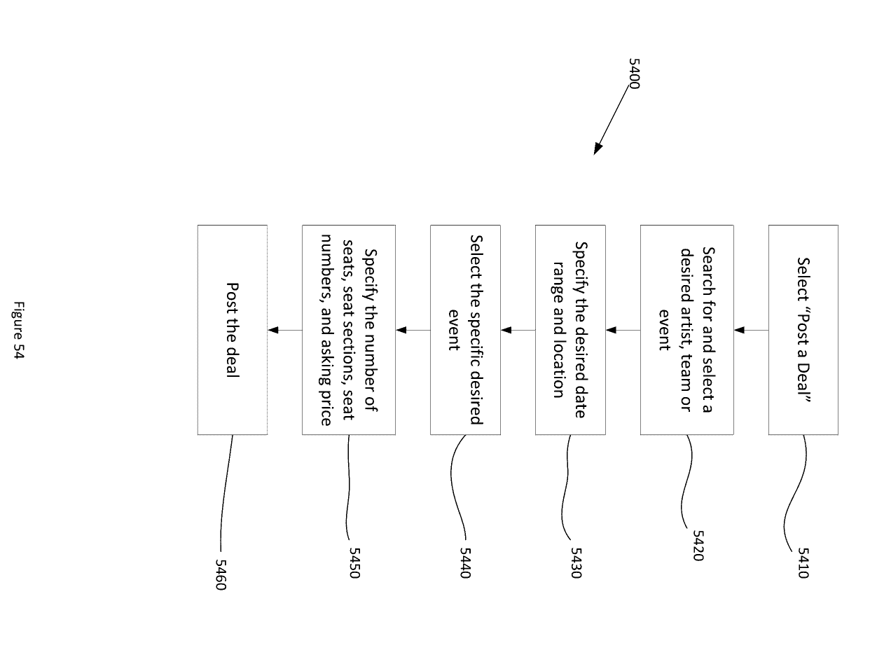

With reference now to FIGS. 31-39, an embodiment of the interface and menus associated with posting a ticket deal or request are provided. On the “create a post” screen 3100, the user may select either the post a deal 3110 option or the post a request 3120 option. If the user selects post a deal 3110, they are taken to the first deal post screen 3200. The process for posting a deal 5400 is shown in FIG. 54. After the user chooses to post a deal 5410, the user first searches for an event using the event list 3200 or event filtering options 3300 in steps 5420 and 5430. After an event has been selected in step 5440, the user may specify the specific ticket information including number of seats, section, row, seat number, and asking price using the ticket detail screen 3400 in step 5450. The user may then post the deal using the inputted information in step 5460. The process for posting a request 5300 is shown in FIG. 53. If the user instead wishes to post a request and selects the request option 3120 in step 5310, they are taken to the first request post screen 3500. As with posting a deal, the user first specifies the event using the event list 3500 or event filtering options 3600 in steps 5320, 5330, and 5340. The user may then specify the number of desired seats, the desired section, and whether or not to be shown on the map, such as map 1900, using the request details screen 3700 in step 5350. The user then posts the deal in step 5360. If a user selects a post a deal option 3810 as shown on screen 3800 without having their user account associated with an electronic payment method, the user may be prompted to either continue without being associated with an electronic payment method or to login to their preferred electronic payment method service as shown in screen 3900.

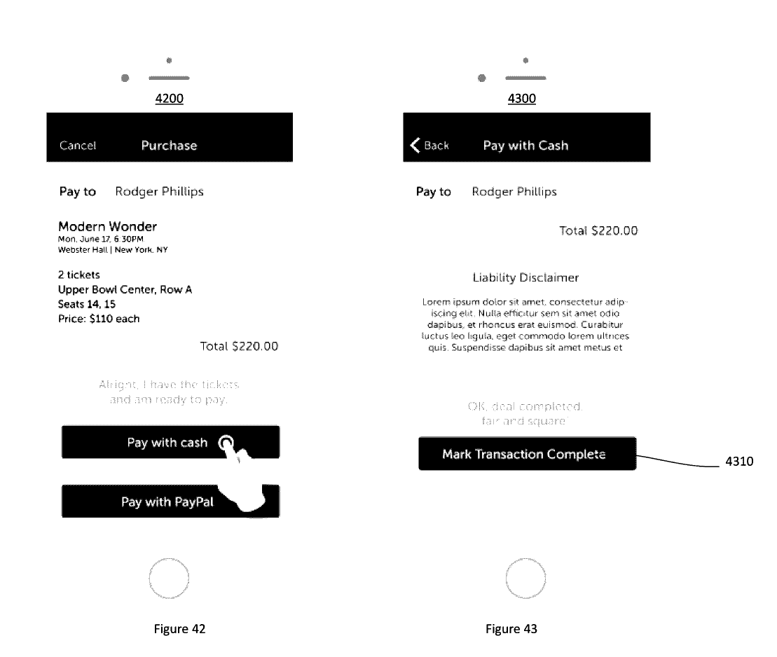

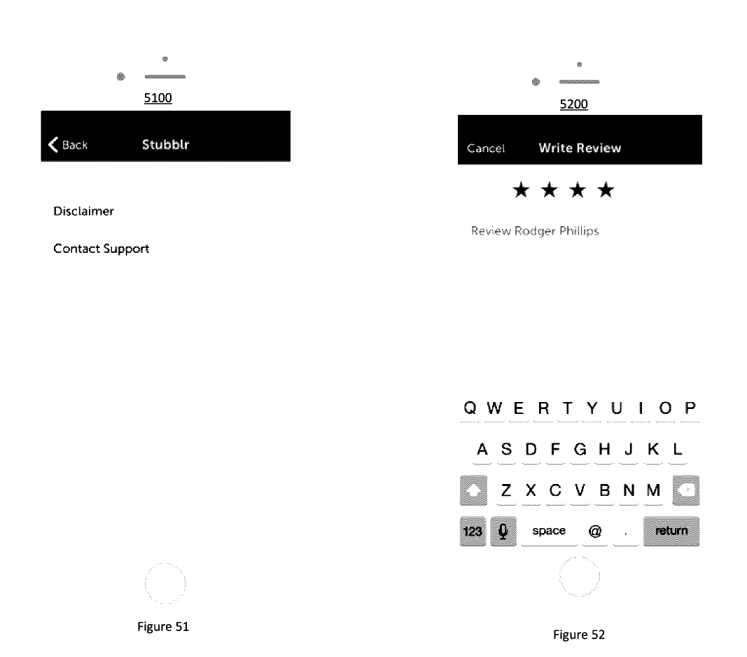

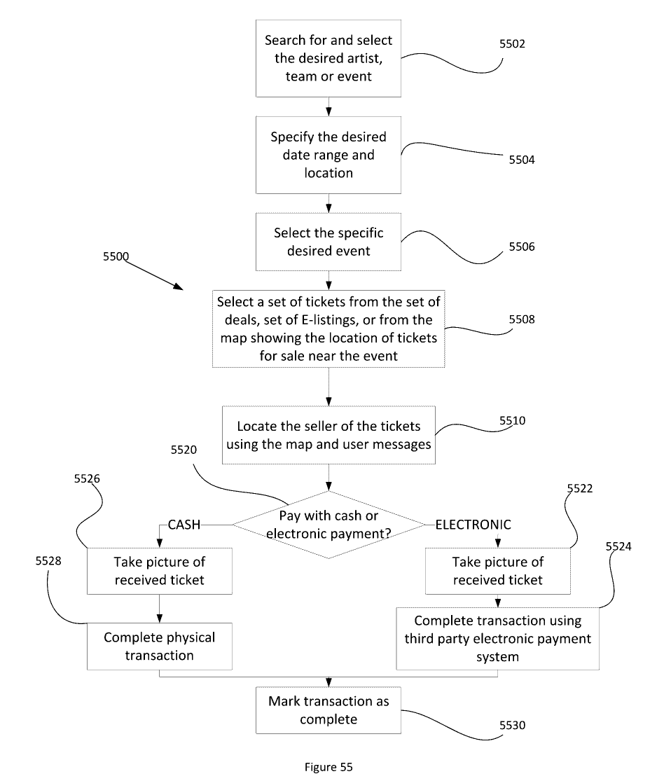

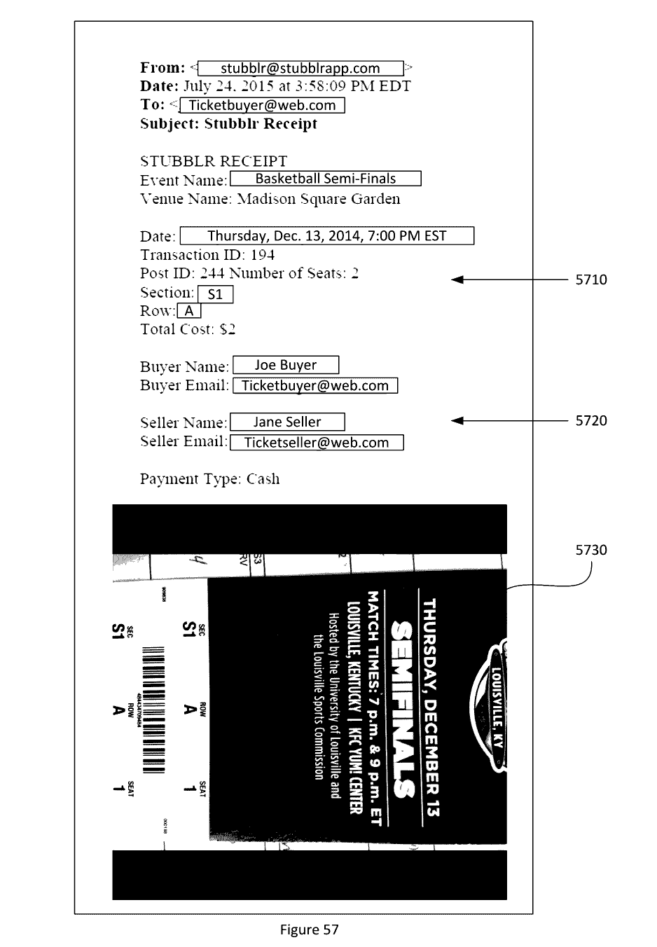

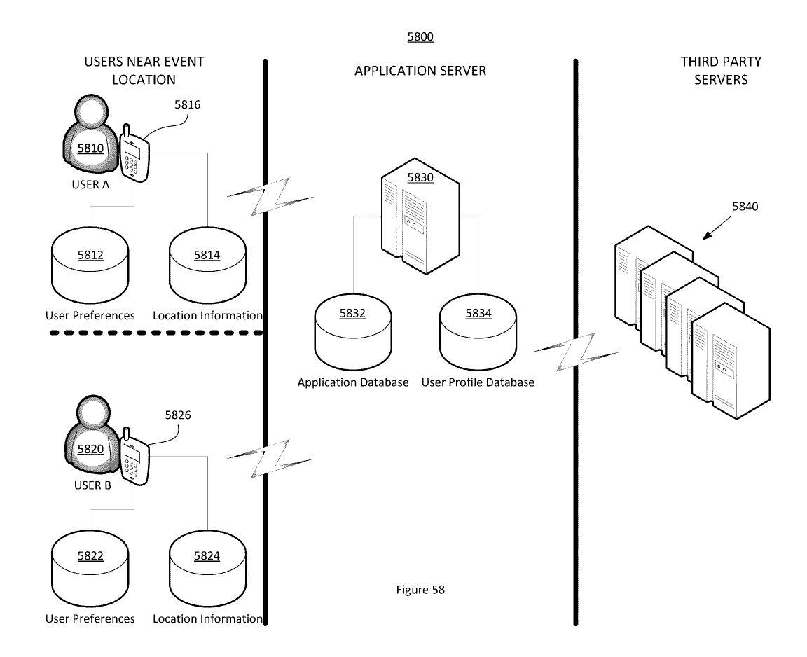

With reference now to FIGS. 42-50 and 57, an embodiment of the interface and menus associated with completing a ticket exchange are provided. The process for purchasing the ticket is shown in the steps 5502-5530 flowchart 5500 in FIG. 55. As shown on purchase screen 4200 the user may either pay with cash or pay with an electronic payment service. If the user wishes to pay with cash or by an electronic payment service they may be required to record evidence of the transaction by photographing the ticket using option 4710 shown on photo and purchase screen 4700. The photo record 4810 is shown on photo and purchase screen 4800. The user may then mark transaction as complete as shown on the pay with cash screen 4300. If the user wishes to pay with an electronic payment service such as PayPal, Google Wallet, Apple Pay, etc., the user will be guided to the third party payment service provider to complete the transaction as shown on electronic payment screens 4400, 4500, and 4600. After a user marks a transaction as complete as shown in screen 4900, the log of the transaction is recorded in the conversation screen 5000 indicating the listing is closed and prompting the user to rate the transaction using the rating screen 5200 as shown in FIG. 52. A receipt of the transaction 5700 shown in FIG. 57 comprises information including ticket information 5710, buyer and seller information 5720, and ticket confirmation information 5730. A user may also access help for the electronic platform using the help screen 5100 shown in FIG. 51 at any time.

With reference first to FIG. 58, a network diagram illustrates how different components of the system 5800 may be connected and interoperate with one another to execute the user interface functions shown in the screenshots of FIGS. 1-57. User A 5810 with mobile device 5816 in this example may be a seller of tickets, and User B 5820 with mobile device 5826 may be a buyer of tickets. Each mobile device 5816 and 5826 may be a device with radio network connectivity, such as a cellular network or Wi-Fi network, and an operating system capable of running a software application such as Google's Android OS, Apple's iOS, or Microsoft's Windows Mobile. Associated with the mobile devices and network connectivity service is a global positioning system (“GPS”) or other locating service. User A 5810 has the mobile device 5816 which stores a set of user preferences 5812 associated with a mobile software application (“app”) associated with the electronic platform of the present invention. The app provides the User A 5810 with the ability to connect to the electronic platform run on the application server 5830. The electronic platform on server 5830 connects User A 5810 with User B 5820 and any number of other users of the electronic platform. User A's 5810 mobile device 5816 also comprises a set of location information 5814 that is communicated to the application server 5830. User B 5820 also has a mobile device 5826 which comprises a set of user preferences 5822 associated with the app and a set of location information 5824. The application server 5830 tracks the location information 5814 and 5824 associated with the users 5810 and 5820 and also updates the user profile database 5834 with user location information and updated user preference information. The application database 5832 stored in the application server 5830 comprises information that may include, but is not limited to, event information, application information, network information, venue information, city information, and third-party server information. The third party servers 5840 comprise a set of third party servers in electronic communication with the application server 5830. The third-party servers 5840 may comprise servers for electronic transaction services, venues, artists or entertainers, and third party ticket sales platforms.

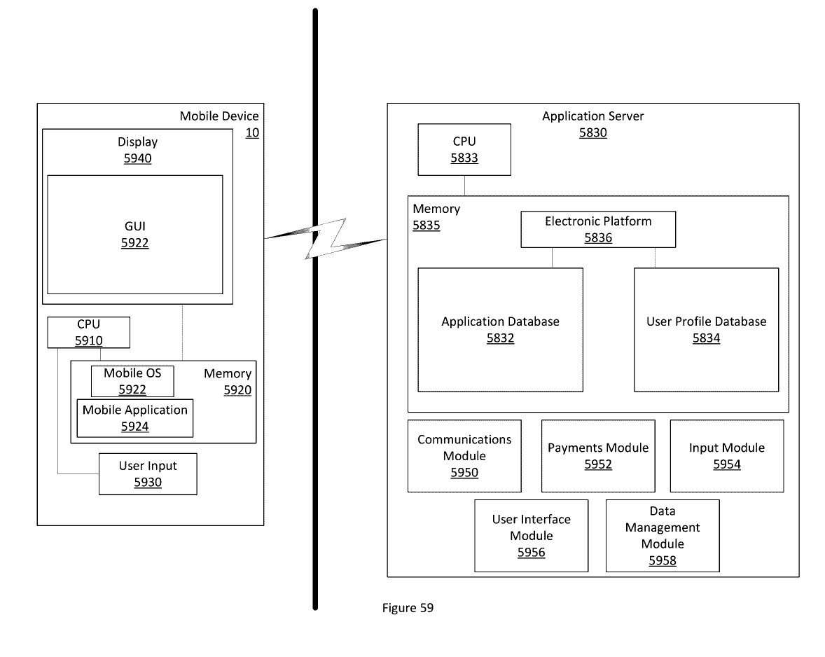

With reference now to FIG. 59, a block system diagram for mobile device 10 and application server 5830 is provided. The mobile device 10 comprises a processor 5910, memory 5920, display 5940, and user input 5930. The user input 5930 may be incorporated in the display 5940 in the form of a touch screen display. The display 5940 provides a graphical user interface 5922 generated by the mobile application 5924. The mobile operating system 5922 coordinates the constituent components of the mobile device 10 and the software stored in the memory 5920. The app 5924 which is shown running on the exemplary mobile device 10 is interacted with by the users through the graphical user interface 5922. The mobile device 10 is in electronic communication with one or more application servers 5830 over a network connection. The application server 5830 may comprise a processor 5833 and a memory 5835. The electronic platform 5836 runs on the server 5830 and is stored in the memory 5835 and is executed by the processor 5833. The memory 5835 may also store one or more databases including the application database 5832 and the user profile database 5834. The application server 5830 may further comprise a communications module 5950, a payments module 5952, an input module 5954, a user interface module 5956, and a data management module 5958. The communications module 5950 is adapted to manage communications between one or more mobile devices and the application server 5830. The communications module 5950 may also be adapted to provide a user interface to the mobile device 10 as generated by the user interface module 5956. The payments module 5952 may be configured to facilitate payments for tickets or offers as described hereinabove and may also communicate with third-party servers or systems to facilitate payments or transactions for tickets or offers. The input module 5954 is configured to receive inputs from mobile devices, third-party servers, and other systems and devices and is further configured to manage these inputs or to route the inputs to the appropriate device, module, or database. The data management module 5958 manages the data stored in the application database 5832, the user profile database 5834, and other data stored on the application server 5830. The communications module 5950, payments module 5952, input module 5954, user interface module 5956, and data management module 5958 may also be configured to perform one or more functions performed by the one or more of the other modules to provide stability or redundancy to the system. Additionally, the communications module 5950, payments module 5952, input module 5954, user interface module 5956, and data management module 5958 may be configured to perform any one or more of the other functions of the system of the present invention as described hereinabove.

Additionally, the present system may be combined with a ticket digitizing service such as that provided by TicketFire or as described in TICKET VALIDATION AND ELECTRONIC CONVERSION OF TICKETS, U.S. P.G. Pub. 2014/0100896, filed Oct. 9, 2013, (Du et al.). Ticket digitizing services may be used to convert a physical ticket into an electronic ticket form. Converting a physical ticket into an electronic ticket can facilitate the transfer of a ticket from one individual to another. For example, two individuals that are not able to meet up with one another using the mapping features described in the present invention may still exchange a ticket that originally only existed in physical form using a ticket digitizing service. The ticket digitizing service or features may be included in or provided as part of the system of the present invention.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A system for facilitating the in-person exchange of goods or services, the system comprising:
a. an application server having a processor and a memory and comprising a communications module adapted to manage communications between the application server, a first user device associated with a first user, and a second mobile device associated with a second user, and wherein the memory comprises computer executable code that when executed by the processor adapted to:
i. receive a posting for an offering comprising a set of offering information from the first mobile device;
ii. store the offering in a database;
iii. receive a request for the offering from the second mobile device;
iv. in response to the request, provide the offering and the set of offering information to the second mobile device;
v. receive a first set of location information from the first mobile device and a second set of location information from the second mobile device;
vi. provide the first set of location information to the second mobile device if a set of criteria are met; and
vii. facilitate and verify an exchange of goods or services between the first user and the second user by receiving a set of verification and purchase information from the first and second mobile devices.

2. The system of claim 1 further comprising wherein a first user profile associated with the first user and a second user profile associated with the second user are stored on the application server.

3. The system of claim 1 wherein the computer executable code executed by the processor of the application server is further adapted to:
a. provide the second mobile device associated with the second user a set of search tools;
b. receive a search query from the second mobile device, the search query specifying a set of desired criteria relating to an event;
c. provide the second mobile device with a set of identified events related to the query;
d. receive an event selection from the second mobile device, the event selection comprising a specific event from the set of identified events; and
e. provide a set of offerings related to the event selection to the second mobile device.

4. The system of claim 3 wherein the request for the offering comprises an offering from the set of offerings.

5. The system of claim 3 wherein the search query comprises one or more of a location, a date, a date range, an event type, an event name, an artist name, a performer name, and an event name.

6. The system of claim 3 wherein the set of offerings are provided to the second mobile device on a map displayed on the second mobile device.

7. The system of claim 6 wherein the map is displayed to the second mobile device if a set of map display criteria are met.

8. The system of claim 7 wherein the set of map display criteria include a proximity to an event venue and a temporal proximity to an event time.

9. The system of claim 1 wherein the set of verification and purchase information is provided by a third party payment processor.

10. The system of claim 1 wherein the set of verification and purchase information comprises a receipt.

11. The system of claim 2 the computer executable code executed by the processor of the application server is further adapted to provide a notification to the second mobile device associated with the second user based on a set of notification criteria stored in the second user profile.

12. The system of claim 1 wherein the first mobile device and the second mobile device monitor and collect a set of tracked information related to the first mobile device and the second mobile device and related to the first user and the second user and transmit the tracked information to the application server, and wherein the computer executable code executed by the processor of the application server is further adapted to:
a. provide a set of location based offers to the second user based in part on the set of tracked information.

13. The system of claim 12 wherein the tracked information comprises global positioning system information, cell tower location information, wireless network information, and social media information.
